(19) United States
(12) Patent Application Publication
(10) Pub. No.: US 2003/0144941 A1
(43) Pub. Date: Jul. 31, 2003

(54) Method for creating and managing investment capital and business organizations

(75) Inventor: Mark J. Lister, Bethesda, MD (US)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(73) Assignee: Sarnoff Corporation

(21) Appl. No.: 10/341,809

(22) Filed: Jan. 14, 2003

Related U.S. Application Data
(60) Provisional application No. 60/348,814, filed on Jan. 15, 2002.

(51) Int. Cl. G06F 17/60

(52) U.S. Cl. 705/36

(57) ABSTRACT

A method for creating and managing investment capital that is jointly managed by joint venturing contractors with input and advice from venture capitalists and government agencies. The method defines a business model that includes an organizational structure to facilitate government agency and private sector teaming, teammates with capabilities matched to this structure, a management process that facilitates government agency oversight, and a venture capital fund to fund technology development. The fund is organized by joint venturing government contractors each of which allocates a portion of the proceeds realized from performance of the government contracts performed by their joint venture, or other capital, to the fund. The fund administrators evaluate early stage private sector technologies through an investment process that involves federal agency officials in an advisory capacity.

### CROSS-REFERENCE TO RELATED APPLICATIONS

This application claims benefit of United States provisional patent application Ser. No. 60/348,814, filed Jan. 15, 2002, which is herein incorporated by reference.

### BACKGROUND OF THE INVENTION

1. Field of the Invention

The present invention generally relates to a business method. More particularly, the invention relates to a method for creating and managing investment capital where venture capitalists, technology research and development entities, and government agencies are involved in the investment and technology development process.

2. Description of the Related Art

In government contracting, a government agency will typically produce a request for proposal (RFP) or Broad Agency Announcement (BAA) to accumulate proposals from various nongovernment entities. The entities bid on a specific contracts for research and development, procurement, or operations and maintenance. The government agency reviews the proposals and awards a contract to the best bidder. Frequently, cutting edge technologies are not acceptable for government contracting efforts because of their high risk nature. However, the cutting edge technologies that exist at the time a proposal is accepted may become less risky as the contract project is developed. Presently, there is not a way that a government agency can easily capitalize on investment from venture capitalists and the business community to utilize certain technologies that would be acceptable to the government agency after the contract has been awarded. Once a contract is awarded, the winning contractor develops the technology without regard to technology developments by others.

Furthermore, many contractors bring individual expertise to a project, but are not capable of supporting a single project having a broad-based purpose. As such, government contracts may be granted to specific contractors to fulfill a specific need within the broad-based purpose. These various contracts make contracting to fulfill a broad-based purpose very complicated, risky, and costly.

Therefore, there is a need in the art for a method by which government agencies can capitalize on investment from venture capitalists and the business world to enhance the research and development efforts that are funded by government agencies. Also, there is a need to organize and manage contractors to flexibly fulfill broad-based purposes.

### SUMMARY OF THE INVENTION

The disadvantages associated with the prior art are overcome by the present invention of a method for creating and managing both investment capital and diverse teams to solve complex problems requiring specific expertise from a broad-base of industry contractors, academic institutions, venture capitalists, and government agencies. The invention comprises a business model that includes an organizational structure to facilitate government agency and private sector teaming, teammates with capabilities matched to this structure, a management process that facilitates government agency oversight, and a venture capital fund to fund technology development. The organizational structure utilizes a plurality of available resources that can be flexibly allocated to fulfill a broad-based purpose. Teammates are comprised of commercial companies, research and development firms, academic institutions, government contractors, consortia, consulting firms, and government organizations. The inclusive management process enables all relevant parties to participate, facilitating teammate communication and collaboration to help insure programmatic success. The capital fund is organized by one or more contractors allocating a portion of the proceeds realized from performance of the government contracts, or other capital, to the fund. The fund administrators evaluate early stage private sector technologies through an investment process that involves federal agency officials in an advisory capacity. These technologies are then available to any contractor for use to complete their government contracts.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a block diagram of a business organization in accordance with one embodiment of the present invention.

FIG. 2 depicts a block diagram of an organizational structure in accordance with the present invention; and

FIG. 3 depicts a process for team management in accordance with the present invention.

### DETAILED DESCRIPTION

The invention is a business model which includes an organizational structure and a management process that teams government agencies with private sector entities (commercial and government contractors, academic institutions, consulting firms, and venture capitalists). A subset of the private sector entities are joint venture members that provide overarching program management of the team and management process, and investment capital to a venture fund. The venture fund is further capitalized with a portion of the proceeds from government projects that are developed by the government contractors that are members of the joint venture.

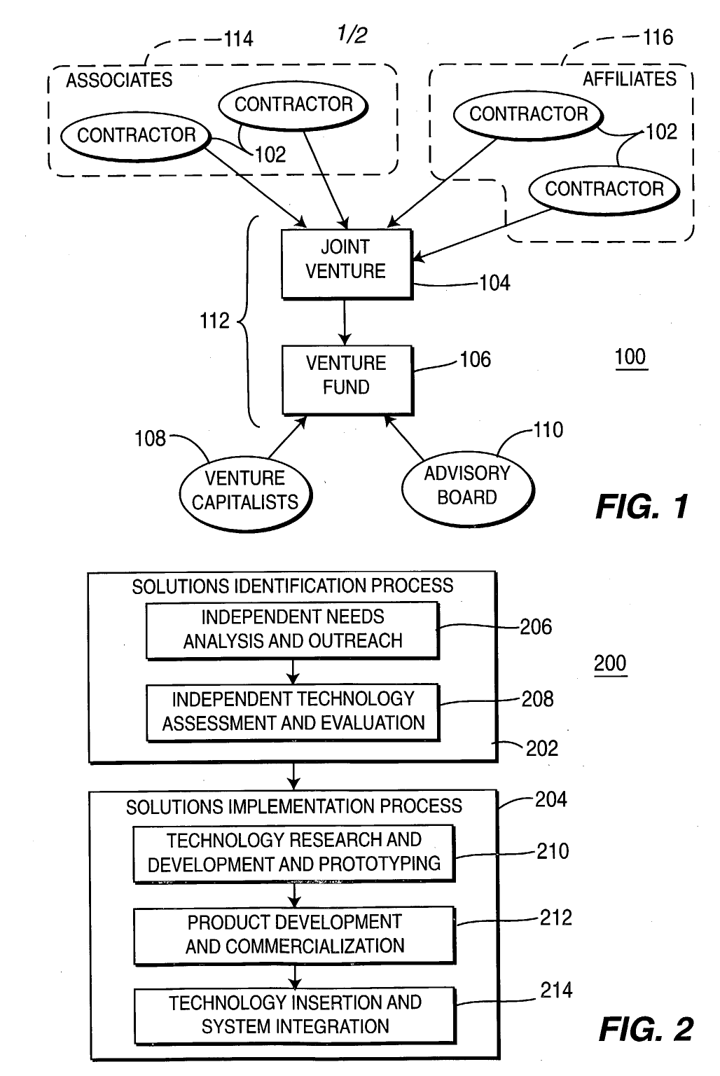

FIG. 1 depicts a block diagram of a business organization 100 of the present invention. The organization 100 comprises a business entity 112 that consists of a joint venture 104 (e.g., a contractual joint venture) and a venture fund 106 (e.g., a limited liability corporation (LLC)). The joint venture 104 comprises contractors that manage a team of other contractors grouped as affiliates 114 and associates 116. The function of affiliates and associates are defined below. In one embodiment of the invention, the joint venturing contractors 104 contractually commit through a limited liability company 106 operating agreement to capitalize the fund with a portion of the proceeds each earns over time through the joint venture, or with other capital. The fund 106 has an investment focus, for example, early stage private sector technologies that may aid the government contractors' ability to fulfill their contractual obligations with government agencies. The potential investment opportunities that may be funded using capital in the fund, are reviewed by venture capitalists 108 and an advisory board 110 that includes officials of the government agencies for which the joint venture performs government contracts. This organization 100 affords government agency officials who serve on the fund's advisory board 110 an opportunity not previously available to see and evaluate early stage private sector technologies in areas which support, or are aligned with, the mission of their agencies.

The organizing principle of the business model is to deliver high value, “best of class” solutions based on commercial technology to fulfill government agency needs by forming conflict free teams of expert organizations (companies, universities, institutes, government organizations, and the like) working toward a common goal. This is accomplished by parsing the organization into the functions necessary to execute an end-to-end program, thus mapping the organizational structure into the programmatic and management functions.

The organization 100 could be provided contracts from a government agency such that some or all the contractors 102 share in the process to fulfill the contract, or the contractors 102 could use the organization to solve particular problems or develop particular technologies for use by the contractor 102 in a contract that is separate from the organization.

The organization can be provided a task order contract that will be fulfilled using associates and affiliates that have particular expertise needed by the task order contract. Such an arrangement will improve the speed at which contracts are processed and fulfilled.

FIG. 2 depicts a block diagram of an organizational structure 200 in accordance with the present invention. The structure 200 comprises a solutions identification process 202 and a solutions implementation process 204. The functions performed in process 202 comprise identification and analysis of user needs in step 206 and technology, product, or service, and market analyses in step 208. The process 204 comprises technology research, development, and prototyping in step 210; product development and commercialization in step 212; and technology insertion and systems integration in step 214. Steps 206 and 208 can be performed by team members known as affiliates (affiliates are defined below). The steps 210, 212 and 214 are performed by team members know as associates.

The highest value for the government agencies is achieved when the expertise and capabilities to execute the functions defined above come from organizations specializing in the required discipline. The team member organization of affiliates and associates is designed to ensure independence of judgment and flexibility for solution implementation. The affiliates are standing members of the team responsible for the solutions identification process 202, which involves needs analysis and outreach, independent technology assessments and evaluations, analysis of commercial technology shortfalls in meeting users' needs, creation of technology development and transfer roadmaps, and technology forecasting. To be an affiliate, a company (or other entity) must be independent—that is not tied to manufacturing or sale of a product or particular technology. This is to ensure that the client government agency receives independent evaluations that identify the best technologies and solutions, which are not influenced by corporate interests. The affiliates include defense analysis companies, commercial technology analysis firms, and market research leaders.

Associates represent the resource pool for solutions implementation (process 204)—responsible for technology research and development and prototyping (step 210), product development and commercialization (step 212), and technology insertion and systems integration (step 214). They provide the joint venture the ability and agility to satisfy client's timely mission requirements. The associates are separated from the solutions identification process 202 by a procedural conflict of interest firewall and do not actively participate in those activities. The associates include leading universities, commercial R&D organizations and laboratories for technology development, market leaders in various areas for product development and improvement, defense systems integrators for technology transition and insertion, and venture capital advisors for technology commercialization. New associates can and will be added to the team if their capabilities or technologies are identified through the solutions identification process as being “best of breed” or in the best interests of the government.

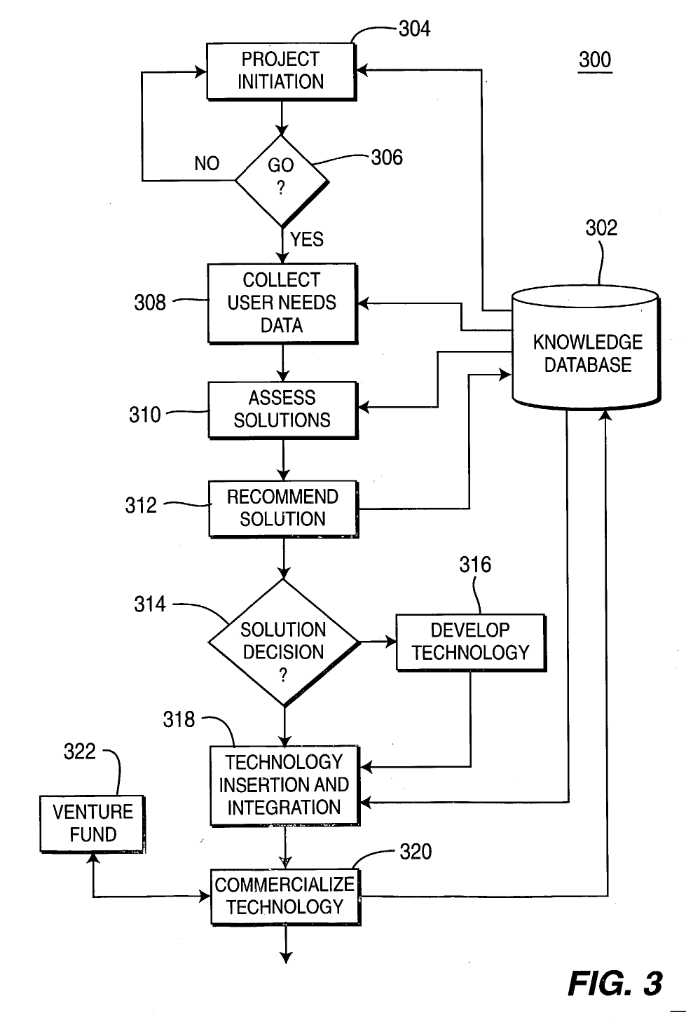

FIG. 3 depicts a flow diagram of an Integrated Project Team (IPT) management process 300. For team management, the joint venture uses an IPT process 300. This process 300 enables all relevant parties to participate such that different team members form different IPTs throughout the process. Such a process fosters the sharing of technical and managerial information, thereby enhancing project management across the affiliates and associates team members. The IPT is self-organizing such that, when a project is initiated, the appropriate affiliates (those involved in site visits and in technology and market analyses to identify the needs and best approaches) become part of the IPT. As the project evolves into solutions implementation, the appropriate associates (those identified as having the best product offering or R&D capabilities) join the IPT. The joint venture management participates in each IPT through all stages of activity and coordinates closely with the client as government participation in the IPT is critical for success. Each project is managed the same way. A key to this multi-organizational management is the collaborative tool of a common knowledge database 302. The knowledge database 302 contains all IPT data on all projects including technical reports, and schedule information. Within the IPT organizational structure, the joint venture applies well established program management disciplines and tools, including work breakdown structures (WBS), discrete program phases with observable milestones and exit criteria, monthly status reports, and major milestone reviews chaired by the director of operations.

The flow diagram of the IPT management process 300 of FIG. 3 reflects the process for a client-directed task whether planned or quick reaction, ad hoc tasks. The IPTs formed for steps 304 through step 312 are part of the solutions identification process 202. The IPTs formed in steps 316, 318 and 320 are part of the solutions implementation process 204. Each IPT accesses information in the knowledge database 302.

A first IPT is formed at step 304 to initiate the solutions identification process 202 by defining the goals and objectives of site visits to uncover client's needs. This step 304 will ensure resources are properly planned and deployed to maximize the return on investment (ROI) for the effort. At step 306, a “go/no go” decision is made in view of the information used to define the project.

A second IPT is formed at step 308 to execute the plan formulated by the first IPT and culminates in documented client's needs vetted with other sites and clients, and identifies technologies, products, or services that are key to solution implementation.

A third IPT is formed at step 310 to identify the associates' capabilities required for solutions implementation including research, technology or product development, systems integration, technology transition or insertion, and commercialization viability.

A fourth IPT is formed at step 312 to review, evaluate and prioritize solution implementation options for client decision. At step 314, the process 300 queries whether a solution is to be developed at step 316 or merely inserted (i.e., purchased “off-the-shelf”) into the solution at step 318.

A fifth IPT is formed at either step 316 or step 318 to perform the technology development or technology insertion plans and manages the solutions implementation project. If a technology is developed at step 316, the development technology is thereafter inserted into the solution at step 318.

A sixth IPT is formed at step 320 to focus on technology commercialization, involving the venture fund, as appropriate. Note that IPTs of steps 316/318 and 320 can run concurrently.

Closely coupled in the approach is the value creation process used in the private sector for commercialization of technology or products. Beginning at the second IPT, the joint venture gains the knowledge of the potential future market. Beginning with the third IPT and continuing through the fourth IPT, the joint venture completes the process of assembling the best team (technology, intellectual property, management, and business case) for eventual commercialization. In later stages of a project, the joint venture works to team the associates with promising commercialization candidates with sources of commercialization funding, including venture capital advisors and the venture fund.

In one embodiment of the invention, the joint venturing government contractors establish the venture fund 106 and commit to invest in this fund 106 all fees earned through the joint venture on the program. The fund 106 is used to provide seed and early stage capital to promising technology projects and companies of significance to client needs. Specific investment decisions will be made with the advice of venture capitalists 108 and government representatives on the advisory board 110.

For discussion purposes, assuming a $50 million program with 10% fee, the joint venturing contractors contribution to the venture fund 106 would total $5 million annually or $25 million over the 5 year life of the program. Over the last 10 to 20 years, such investments have generated average yields of 20-30% per year from the time of the investment to the time that equity is liquidated. It is assumed that the investments will be sold (either through public offerings or acquisitions) at four years. Based on these assumptions, the asset value of the Fund after five years will be in excess of $30 million. Beginning in the middle of the fifth year, 75% of the distributions from the fund 106 will be reinvested. Using growth models widely accepted in the venture capital community, the fund 106 has the potential to grow in investment value to $50 million by the eighth year. Investment activities will be managed by a professional staff, funded by a management fee of 2.5% per year on the committed capital. This revolutionary approach positions the client to participate in the broad venture capital-financed research and development world to influence early stage investments, gain knowledge of future technologies likely to emerge in two to five years to enable program managers to plan for technology insertion, and be at the leading edge of technology acquisition for the U.S. Government.

Teamwork is required to provide solutions for clients having large projects. The collective efforts must complement each other. Successful teamwork demands leadership from conception through implementation. The business model epitomizes this comprehensive leadership. The joint venture adds value through its organization and management approach, which aligns to all the functions necessary for successful delivery of solutions to government agencies. This streamlined approach promotes unbiased decisions and fairness, exploits teammate expertise, and reduces administrative burden and costs. Further, management value is added by ensuring a disciplined approach to all tasks and allowing for informed decisions based on validated information. The joint venture adds value through its teaming approach and teammates, by eliminating conflict of interest, and providing partnering opportunities. Multidisciplinary teams of experts can quickly be created to address user needs without the threat of competition. For example, value is created when a product development company is teamed with an independent R&D entity to enhance a product. ROI increases further when a system integrator is added to incorporate the new product into a fielded system. Finally, the joint venture adds value by involving venture capitalists and having a venture fund available. The joint venture management will introduce the teammates to the leading market value creation process. This process marries technology, intellectual property, a management team, and a promising business case to attract investment either from corporate investors or venture capitalists.

While foregoing is directed to the preferred embodiment of the present invention, other and further embodiments of the invention may be devised without departing from the basic scope thereof, and the scope thereof is determined by the claims that follow.

1. A business model comprising:
a business entity having as investors one or more joint venturing contractors that serve as an overarching manager to manage a plurality of contractors and to solve complex problems for government agencies;
a venture fund having capital provided by the business entity, where the venture fund has an advisory board comprising venture capitalists and representatives of entities that provide contracts to the plurality of contractors, and where said venture fund applies capital to entities that develop technology that is related to the contracts.

2. The business model of claim 1 wherein the joint venturing contractors supply a percentage of profit from the contracts to the venture fund.

3. The business model of claim 1 wherein the contracts are government contracts and the entities that provide contracts are government agencies.

4. The business model of claim 1 wherein the contractors are grouped according to at least one of core competencies or expertise as either associates or affiliates.

5. The business model of claim 4 wherein the affiliates perform solution identification and the associates perform solution implementation.

6. A method for creating and managing investment capital for a venture fund comprising:
a) initiating a project;
b) collecting user needs data;
c) assessing solutions for identified user needs;
d) recommending a solution;
e) developing technology to achieve the solution or purchasing the technology for the solution;
f) inserting the technology into the solution;
g) commercializing the solution using capital from a venture fund;
steps a), b), c) and d) are performed by affiliates of the business entity and steps e), f) and g) are performed by associates of the business entity.

7. The method of claim 6 wherein joint venturing contractors supply a percentage of profit from the contracts to the venture fund.

8. The method of claim 6 wherein the project is initiated by a contract from at least one government agency.

9. The method of claim 6 wherein contractors are grouped according to at least one of core competencies or expertise as either associates or affiliates.

10. The method of claim 9 wherein the affiliates perform solution identification and the associates perform solution implementation.

11. A method for organizing an integrated project team comprising:
defining tasks to be performed to fulfill a broad-based purpose;
providing a plurality of members, each having a specific expertise;
identifying one or more members from the plurality available that have a specific expertise to fulfill each of the tasks;
selecting the identified team members as members of the integrated project team; and
performing the tasks using the integrated project team to complete the broad-based purpose.

12. The method of claim 11 wherein the broad-based purpose is defined by a government contract.

13. The method of claim 11 wherein the team members comprise associates and affiliates that are grouped in accordance with at least one of their competencies or expertise.
